(19) United States
(12) Patent Application Publication
(10) Pub. No.: US 2026/0081218 A1
(43) Pub. Date: Mar. 19, 2026

(54) ELECTROLYTE AND LITHIUM SECONDARY BATTERY INCLUDING THE SAME

(71) Applicants: SAMSUNG SDI CO., LTD., Yongin-si Gyeonggi-do (KR); THE TRUSTEES OF COLUMBIA UNIVERSITY IN THE CITY OF NEW YORK, New York, NY (US)

(72) Inventors: Hyunsik WOO, Yongin-Si (KR); Yuanyuan MA, Yongin-Si (KR); Yang LI, Yongin-Si Gyeonggi-do (KR); Jungjoon KIM, Yongin-Si Gyeonggi-do (KR); Yongseok KIM, Yongin-Si Gyeonggi-do (KR); Yuan YANG, New York, NY (US); Shengyu CONG, New York, NY (US); Zhenghao YANG, New York, NY (US)

(73) Assignees: SAMSUNG SDI CO., LTD., Yongin-si Gyeonggi-do (KR); THE TRUSTEES OF COLUMBIA UNIVERSITY IN THE CITY OF NEW YORK, New York, NY (US)

(21) Appl. No.: 19/324,420

(22) Filed: Sep. 10, 2025

Related U.S. Application Data
(60) Provisional application No. 63/696,404, filed on Sep. 19, 2024.

(51) Int. Cl. H01M 10/0565; H01M 4/02; H01M 4/38; H01M 10/052; H01M 10/0568; H01M 10/0569

(52) U.S. Cl. CPC H01M 10/0565; H01M 4/382; H01M 10/052; H01M 10/0568; H01M 10/0569; H01M 2004/027; H01M 2300/0028

(57) ABSTRACT

The present disclosure relates to an electrolyte, and a lithium secondary battery including the electrolyte. An electrolyte according to the present disclosure may include a copolymer of an acrylic monomer and a fluoroacrylic monomer, and the fluoroacrylic monomer may include 7 or more fluorine atoms. A lithium secondary battery may include a cathode, an anode including an anode current collector, and an electrolyte according to the present disclosure disposed between the cathode and the anode.

### CROSS REFERENCE TO RELATED APPLICATION

The present application claims priority to U.S. Provisional Application No. 63/696,404, filed on Sep. 19, 2024, the entire disclosure of which is incorporated by reference herein.

### BACKGROUND

### Field

The present disclosure relates to an electrolyte, and to a lithium secondary battery including the electrolyte.

### Description of the Related Art

The demand for high-energy-density secondary batteries continues to increase due to the expansion of the electric vehicle market and the need for longer-lasting portable electronic devices. Lithium metal batteries (LMBs) are attractive candidates for next-generation energy storage devices due to the high theoretical specific capacity and low electrochemical potential of the lithium metal anode.

Conventional liquid electrolytes generally consist of a flammable organic carbonate-based solvent. This inherent flammability, combined with the high reactivity of lithium metal, causes a substantial thermal runaway risk, when an internal short circuit occurs. Although some improved liquid electrolytes have been developed, these liquid electrolytes often provide only a limited improvement in cycle life, and do not completely address the safety concerns.

Therefore, an advanced electrolyte system that can enable the formation of a stable, substantially uniform, and protective solid electrolyte interphase (SEI) on the anode, thereby reducing or suppressing dendrite growth, improving cycling stability and coulombic efficiency, and enhancing the overall safety of anode-free lithium secondary batteries, may be advantageous.

### SUMMARY

The present disclosure describes an electrolyte, and a lithium secondary battery including the electrolyte, which can solve the issues described above.

The technical problems to be solved by the present invention are not limited to the above-mentioned problems, and other unmentioned problems may be clearly understood by a person skilled in the art from the detailed description of the disclosure described below.

According to an example embodiment, an electrolyte may include a copolymer of an acrylic monomer and a fluoroacrylic monomer, and the fluoroacrylic monomer may include 7 or more fluorine atoms.

According to an example embodiment, a lithium secondary battery may include a cathode, an anode including an anode current collector, and an electrolyte disposed between the cathode and the anode. The electrolyte may include a copolymer of an acrylic monomer and a fluoroacrylic monomer, and the fluoroacrylic monomer may include 7 or more fluorine atoms.

An electrolyte according to some example embodiments of the present disclosure may include a copolymer of an acrylic monomer and a fluoroacrylic monomer. An ester group and a CFₓ group constitute amphiphilic sites for a lithium cation, thereby promoting a substantially uniform lithium-ion flux distribution and effectively reducing or preventing local hot spots and dendrite growth. In addition, the electrolyte accommodates volume changes during lithium metal deposition and stripping, allowing lithium to be deposited more densely and more uniformly.

According to some example embodiments of the present disclosure, because the electrolyte includes a copolymer formed from or including a fluoroacrylic monomer including 7 or more fluorine atoms, an initial nucleation process may be controlled, and a lithium secondary battery with improved cycling performance may be readily realized. In addition, rich C—F bonds may enhance coordination ability, thereby readily forming a dynamically evolving Li—F-rich solid electrolyte interphase (SEI) to protect the lithium metal and reduce or prevent excessive electrolyte consumption. Accordingly, the electrolyte may reduce charge transfer resistance, improve the morphology and density of the deposited lithium, and reduce or suppress the cracking of lithium.

A lithium secondary battery according to some example embodiments of the present disclosure may have improved cycling performance and desired or improved thermal stability.

The effects that can be obtained through examples of the present disclosure are not limited to the effects described above, and other technical effects that are not mentioned may be clearly understood by a person skilled in the art from the detailed description of the disclosure described below.

### BRIEF DESCRIPTION OF THE DRAWINGS

The following drawings attached to the present specification illustrate an example embodiment of the present disclosure and serve to further enhance the understanding of the technical idea of the present disclosure in conjunction with the detailed description of the disclosure described below, and thus the present disclosure is not to be construed as being limited to the matters described in the drawings.

FIG. 1 is a diagram illustrating a stacked structure of a lithium secondary battery according to an example embodiment of the present disclosure.

FIG. 2 is a diagram illustrating a stacked structure of the lithium secondary battery of FIG. 1 after charging.

FIG. 3 is a diagram illustrating a stacked structure of a lithium secondary battery according to an example embodiment of the present disclosure.

FIG. 4 is a diagram illustrating a lithium secondary battery according to an example embodiment of the present disclosure.

FIG. 5 is a diagram illustrating a lithium secondary battery according to an example embodiment of the present disclosure.

FIG. 6 is a diagram illustrating a lithium secondary battery according to an example embodiment of the present disclosure.

FIG. 7 is a diagram illustrating a lithium secondary battery according to an example embodiment of the present disclosure.

FIG. 8 is an image illustrating contact angles of an electrolyte of an Example and Comparative Examples according to an evaluation example.

FIG. 9 is an image illustrating capacity retention rates of an Example and Comparative Examples according to an evaluation example.

FIG. 10 is an image of an SEI layer of a lithium secondary battery of an Example, Comparative Examples, and a Reference Example, photographed with a Cryo-TEM according to an evaluation example.

FIG. 11 is an image of an anode surface of a lithium secondary battery of an Example, Comparative Examples, and a Reference Example, photographed with an SEM according to an evaluation example.

FIG. 12 is an image of an anode surface of a lithium secondary battery of an Example, Comparative Examples, and a Reference Example, photographed with a FIB-SEM according to an evaluation example.

### DETAILED DESCRIPTION

Hereinafter, example embodiments of the present disclosure are described in detail. However, the embodiments are presented as an example, and the present disclosure is not limited by the disclosed embodiments, and the present disclosure is only defined by the scope of the claims described below.

In the present specification, unless otherwise specified, when a part such as a layer, a film, a region, or a plate is said to be “on” another part, this includes not only a case where the part is “directly on” the other part, but also a case where there is another part in between.

In the present specification, unless otherwise specified, a singular expression may also include a plural expression. In addition, unless otherwise specified, “A or B” may mean “including A, including B, or including A and B.”

In the present specification, “a combination thereof” may mean a mixture, a laminate, a composite, a copolymer, an alloy, a blend, and a reaction product of a component, and the like.

Methods and materials similar or equivalent to those described in the present specification may be used in the practice or testing of the present disclosure, but suitable methods and materials are described in the present specification. A singular expression may include a plural expression unless the context clearly dictates otherwise.

In the present specification, terms such as “include,” “comprise” or “have” are intended to indicate the presence of a feature, a number, a step, an operation, a component, a part, an ingredient, a material, or a combination thereof described in the specification, and are not to be understood as precluding the presence or addition of one or more other features, numbers, steps, operations, components, parts, ingredients, materials, or combinations thereof.

In the present specification, the term “and/or” means including any and all combinations of one or more of the associated listed items. In the present specification, the term “or” means “and/or.”

In the present specification, the terms “first,” “second,” and the like, may be used to describe various components, but the components should not be limited by the above terms. The terms are used only for the purpose of distinguishing one component from another component.

In the present specification, “metal” includes both a metal and a metalloid such as silicon and germanium, in an elemental state or an ionic state. In the present specification, the term “alloy” indicates a mixture of two or more metals.

In the present specification, “cathode active material” indicates a cathode material that may undergo lithiation and delithiation. In the present specification, “anode active material” indicates an anode material that may undergo lithiation and delithiation.

In the present specification, “lithiation” and “to lithiate” indicate a process of adding lithium to a specific substance or compound. In the present specification, “delithiation” and “to delithiate” indicate a process of removing lithium from a specific substance or compound.

In the present specification, “charging” and “to charge” indicate a process of providing electrochemical energy to a battery. In the present specification, “discharging” and “to discharge” indicate a process of removing electrochemical energy from a battery.

In the present specification, “positive electrode” and “cathode” indicate an electrode where electrochemical reduction and lithiation occur during a discharging process. In the present specification, “negative electrode” and “anode” indicate an electrode where electrochemical oxidation and delithiation occur during a discharging process.

When the terms “about” or “substantially” are used in this specification in connection with a numerical value, it is intended that the associated numerical value include a tolerance of +10% around the stated numerical value. The expression “up to” includes amounts of zero to the expressed upper limit and all values therebetween. When ranges are specified, the range includes all values therebetween such as increments of 0.1%.

Hereinafter, example embodiments are described in more detail.

Examples embodiments of the present disclosure relate to an electrolyte for use in a lithium secondary battery, particularly an anode-free and a lithium-metal battery, and a battery including the electrolyte. The electrolyte of the present disclosure may form a substantially stable solid electrolyte interphase (SEI) on the anode surface, and may readily realize a lithium secondary battery with improved cycle stability, coulombic efficiency, and safety.

To solve the problems of inferior cycle life and thermal instability caused by an unstable positive electrode morphology and parasitic reactions in a lithium secondary battery, example embodiments of the present disclosure provide an electrolyte including an in-situ polymer formed from an amphiphilic fluoroacrylic monomer that functions as a surfactant. The polymer may utilize the synergistic effect of a network-forming branched acrylic monomer and a fluoroacrylic monomer to create a localized high-concentration environment within a gel matrix. This may induce an anion-rich solvation structure, and as a result, the anion-derived SEI may significantly promote the reversibility of lithium deposition and stripping, increase cycle life, and improve the thermal stability of the electrolyte.

### Electrolyte

In an example embodiment, an electrolyte may include a copolymer of an acrylic monomer and a fluoroacrylic monomer. The fluoroacrylic monomer may include about 7 or more fluorine atoms. An electrolyte according to some example embodiments of the present disclosure may include a copolymer of an acrylic monomer and a fluoroacrylic monomer, so that an ester group and a CFₓ group constitute amphiphilic sites for a lithium cation, thereby promoting a substantially uniform lithium-ion flux distribution and effectively reducing or preventing local hot spots and dendrite growth. In addition, the electrolyte may manage volume changes during lithium metal deposition and stripping to deposit lithium more densely and substantially uniformly. A characteristic C═C bond peak of approximately 1640 cm⁻¹ present in the monomer may decrease significantly after a heating and gelling process, indicating complete, or substantially complete, polymerization.

According to some example embodiments of the present disclosure, because the electrolyte includes a copolymer formed from a fluoroacrylic monomer including about 7 or more fluorine atoms, an initial nucleation process may be controlled, and a lithium secondary battery with improved cycling performance may be readily realized. In addition, rich C—F bonds may enhance coordination ability, thereby readily forming a dynamically evolving Li—F-rich solid electrolyte interphase (SEI) to protect the lithium metal and reduce or prevent excessive electrolyte consumption. Accordingly, the electrolyte may reduce charge transfer resistance, improve the morphology and density of the deposited lithium, and reduce or suppress the cracking of lithium.

In an example embodiment, an acrylic monomer may perform a cross-linker role. A fluoroacrylic monomer may perform a surfactant role. A fluoroacrylic monomer may have an amphiphilic structure having a lithiophilic acrylate “head” portion and a lithiophobic fluorocarbon “tail” portion.

An acrylic monomer and a fluoroacrylic monomer may form a copolymer through an in-situ polymerization process. In the in-situ polymerization process, the fluoroacrylic monomer may be integrated into a gel network through a lithiophilic acrylate head portion, and the lithiophobic tail may aggregate through perfluorocarbon interactions. This configuration may physically separate a liquid electrolyte into a plurality of nanoscale regions to create a localized high-concentration environment within the gel network. This may form an anion-rich solvation structure around a lithium ion. The anion-rich solvation structure may readily form inorganic lithium compounds such as LiF and Li₂O in the SEI at the anode during battery operation. An inorganic-rich SEI with a high Young's modulus may be mechanically strong to reduce or suppress lithium dendrite growth, and may readily form a higher chemical stability and a lower Li+ diffusion barrier.

In addition to a repulsive force from the electrolyte, the lithiophobic fluorocarbon tail of the fluoroacrylic monomer has an amphiphilic property because the tail tends to aggregate. When a fluoroacrylic monomer has less than 7 fluorine atoms, this aggregation is not observed.

After a copolymer of an acrylic monomer and a fluoroacrylic monomer is gelled, a cross-linked polymer network may be formed. The cross-linked polymer network may have a porous structure and may create a localized high-concentration environment in each nanoscale pore. Accordingly, an anion-rich solvation structure may be readily formed.

The spectrum for lithium salt anions may be deconvoluted to determine a ratio of free anions (FA), contact ion pairs (CIP), and ion aggregates (AGG). The proportion of AGG anions increases with a longer fluorocarbon chain. The polymer of the present disclosure has a higher AGG ratio, thereby exhibiting an anion-rich solvation structure, and when a surfactant molecule with a long fluorocarbon chain is incorporated into a gel electrolyte, anions may preferentially coordinate with a lithium cation.

The polymer of the present disclosure may exhibit a stronger anion-Li⁺ interaction in an anion-rich solvation environment due to an increased electron density around a Li⁺ nucleus resulting from stronger shielding by the coordinating anions.

An anion-derived SEI formed from an electrolyte of the present disclosure may promote interfacial charge transfer and may have a lower charge transfer resistance. Lower charge transfer resistance may increase coulombic efficiency (CE), which measures the reversibility of lithium plating and stripping. A long fluorocarbon chain of a fluoroacrylic monomer may improve the reversibility of a lithium anode. A surface of the SEI may be rich in fluorine-rich domains having a size in a range of about 50 nm to about 100 nm. The fluorine-rich SEI may regulate interfacial charge transfer and result in smoother and denser lithium deposition. A battery with desired or improved cycle performance may be readily realized due to a combination of a high LiF content, an appropriate domain size, and an appropriate lithium density of the SEI.

A lithium secondary battery of the present disclosure may have desired or improved thermal stability because a higher concentration of fluorine radicals generated during heating constitutes a flame retardant.

In an example embodiment, a fluoroacrylic monomer may include 1H,1H,2H,2H-heptadecafluorodecyl (meth)acrylate, 1H,1H,5H-octafluoropentyl (meth)acrylate, 1H,1H,2H,2H-nonafluorohexyl (meth)acrylate, 2,2,3,3,4,4,5,5,6,6,7,7-dodecafluoroheptyl (meth)acrylate or 3,3,4,4,5,5,6,6,7,7,8,8,9,9,10,10,11,11,12,12,12-heneicosafluorododecyl (meth)acrylate. By selecting the type of fluoro monomer as described above, a substantially uniform lithium-ion flux distribution may be promoted and local hot spots and dendrite growth may be effectively reduced or prevented.

In an example embodiment, a weight of a fluoroacrylic monomer may be greater than or equal to about 0.1 wt % and less than or equal to about 20 wt % of the weight of an electrolyte. For example, a weight of a fluoroacrylic monomer may be greater than or equal to 0.5 wt % and less than or equal to 15 wt %, greater than or equal to 1 wt % and less than or equal to 10 wt %, greater than or equal to 1.5 wt % and less than or equal to 5 wt %, greater than or equal to 2.0 wt % and less than or equal to 3 wt %, greater than or equal to 0.1 wt % and less than or equal to 2.5 wt %, or greater than or equal to 2.5 wt % and less than or equal to 3.0 wt % of the weight of an electrolyte. By controlling a content of a fluoroacrylic monomer within the above-mentioned range, a substantially uniform lithium-ion flux distribution may be promoted and local hot spots and dendrite growth may be effectively reduced or prevented. A weight of a fluoroacrylic monomer may be greater than or equal to about 2.0 wt % and less than or equal to about 3.0 wt % of the weight of an electrolyte.

In an example embodiment, an acrylic monomer may include at least one of bisphenol A ethoxylate diacrylate, bisphenol A ethoxylate dimethacrylate, triethylene glycol diacrylate (TEGDA), triethylene glycol dimethacrylate (TEGDMA), polyethylene glycol diacrylate (PEGDA), polyethylene glycol dimethacrylate (PEGDMA), trimethylolpropane triacrylate (TMPTA), trimethylolpropane trimethacrylate (TMPTMA), pentaerythritol triacrylate (PET3A), pentaerythritol trimethacrylate (PET3MA), pentaerythritol tetraacrylate (PETTA), pentaerythritol tetramethacrylate (PETTMA), ethoxylated trimethylol propane triacrylate (EOTMPTA), propoxylated glyceryl triacrylate (PGTA), dipentaerythritol pentaacrylate (DPEPA), dipentaerythritol hexaacrylate (DPHA), or a combination thereof. By selecting the type of acrylic monomer as described above, a copolymer may be effectively cross-linked and readily formed. Accordingly, a lithium secondary battery with desired or improved coulombic efficiency, cycle performance, and thermal stability may be readily realized.

In an example embodiment, a weight of an acrylic monomer may be greater than or equal to about 0.1 wt % and less than or equal to about 20 wt % of the weight of an electrolyte. For example, a weight of an acrylic monomer may be greater than or equal to 0.5 wt % and less than or equal to 15 wt %, greater than or equal to 1 wt % and less than or equal to 10 wt %, greater than or equal to 1.5 wt % and less than or equal to 5 wt %, greater than or equal to 2.0 wt % and less than or equal to 3 wt %, greater than or equal to 0.1 wt % and less than or equal to 2.5 wt %, or greater than or equal to 2.5 wt % and less than or equal to 3.0 wt % of the weight of an electrolyte. By controlling a content of an acrylic monomer within the above-mentioned range, a copolymer may be effectively cross-linked and readily formed. Accordingly, a lithium secondary battery with desired or improved coulombic efficiency, cycle performance, and thermal stability may be readily realized. A weight of an acrylic monomer may be greater than or equal to about 2.0 wt % and less than or equal to about 3.0 wt % of the weight of an electrolyte.

In an example embodiment, a weight ratio of a fluoroacrylic monomer and an acrylic monomer may be in a range of about 3:7 to about 7:3. For example, a weight ratio of a fluoroacrylic monomer and an acrylic monomer may be 3.2:6.8 to 6.8:3.2, 3.5:6.5 to 6.5:3.5, 3.7:6.3 to 6.3:3.7, or 4:6 to 6:4. By controlling a weight ratio of a fluoroacrylic monomer and an acrylic monomer within the above-mentioned range, a substantially uniform lithium-ion flux distribution may be promoted, and local hot spots and dendrite growth may be effectively reduced or prevented. The aggregation of the lithophobic fluorocarbon tails may be reduced or prevented from forming to an excessive degree, thereby reducing or preventing an obstruction of ion migration. Furthermore, the aggregation of the lithophobic fluorocarbon tails may reduce or prevent unreacted fluoro monomers from being generated due to steric hindrance, which can lead to the deterioration of cell performance through electrochemical side reactions. Moreover, a locally high-concentration environment can be induced by the fluorocarbon tails.

An electrolyte according to an example embodiment of the present disclosure may include a lithium salt and an organic solvent. A gel polymer electrolyte may be formed as a cross-linked polymer is impregnated with a liquid electrolyte.

A lithium salt may include at least one of LiPF₆, LiBF₄, LiTFSI, LIFSI, LIDFOB, LiBOB, or a combination thereof. A concentration of a lithium salt is, for example, in a range of about 0.1 M to about 5.0 M.

An electrolyte may be or include, for example, at least one of a liquid electrolyte, a solid electrolyte, a gel electrolyte, or a combination thereof.

An electrolyte may include, for example, an organic electrolytic solution. An organic electrolytic solution is prepared, for example, by dissolving a lithium salt in an organic solvent. For example, an organic solvent may be or include at least one of a carbonate-based, ester-based, ether-based, ketone-based, or alcohol-based solvent, an aprotic solvent, or a combination thereof. In an example embodiment, an organic solvent may include a carbonate-based solvent.

A carbonate-based solvent may include at least one of fluoroethylene carbonate (FEC), dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like.

An ester-based solvent may include at least one of methyl acetate, ethyl acetate, n-propyl acetate, dimethyl acetate, methylpropionate, ethylpropionate, decanolide, mevalonolactone, valerolactone, caprolactone, or the like.

An ether-based solvent may include at least one of dibutyl ether, tetraglyme, diglyme, dimethoxyethane, 2-methyltetrahydrofuran, 2,5-dimethyltetrahydrofuran, tetrahydrofuran, or the like.

A ketone-based solvent may include cyclohexanone or the like. An alcohol-based solvent may include at least one of ethyl alcohol, isopropyl alcohol, or the like. An aprotic solvent may include at least one of nitriles such as R—CN (R is a linear, branched, or cyclic hydrocarbon group having 2-20 carbon atoms and may include a double bond, an aromatic ring, or an ether group); amides such as dimethylformamide; dioxolanes such as 1,3-dioxolane or 1,4-dioxolane; sulfolane, or the like.

Alternatively, an organic solvent may be or include, for example, at least one of propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N,N-dimethylformamide, dimethylacetamide, dimethylsulfoxide, dioxane, 1,2-dimethoxyethane, sulfolane, dichloroethane, chlorobenzene, nitrobenzene, diethylene glycol, dimethyl ether, or a mixture thereof.

A solid electrolyte is or includes, for example, at least one of an oxide-based solid electrolyte, a sulfide-based solid electrolyte, a polymer solid electrolyte, or a combination thereof.

A solid electrolyte is or includes, for example, an oxide-based solid electrolyte. An oxide-based solid electrolyte is or includes one or more of Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (O≤x<1, O≤y<1), Pb(Mg_{1/3}Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2, 0<y<3), LiₓAl_{y}Ti_{z}(PO₄)₃ (0<x<2,0<y<1, 0<z<3), Li_{1+x+y}(Al, Ga)ₓ(Ti, Ge)₂₋ₓSi_{y}P_{3-y}O₁₂ (0≤x≤1, 0≤y≤1), LiₓLa_{y}TiO₃ (0<x<2, 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (M=Te, Nb, or Zr, x is an integer from 1 to 10). A solid electrolyte is manufactured by a sintering method or the like. For example, an oxide-based solid electrolyte is a Garnet-type solid electrolyte such as or including at least one of Li₇La₃Zr₂O₁₂ (LLZO) and Li₃₊ₓLa₃Zr₂₋ₐMaO₁₂ (M doped LLZO, M=Ga, W, Nb, Ta, or Al, and x is an integer from 1 to 10).

A sulfide-based solid electrolyte may include, for example, at least one of lithium sulfide, silicon sulfide, phosphorus sulfide, boron sulfide, or a combination thereof. A sulfide-based solid electrolyte particle may include at least one of Li₂S, P₂S₅, SiS₂, GeS₂, B₂S₃, or a combination thereof. A sulfide-based solid electrolyte particle may be Li₂S or P₂S₅. A sulfide-based solid electrolyte particle has higher lithium ion conductivity than other inorganic compounds. For example, a sulfide-based solid electrolyte includes Li₂S and P₂S₅. When a sulfide solid electrolyte material constituting the sulfide-based solid electrolyte includes Li₂S—P₂S₅, a mixed molar ratio of Li₂S to P₂S₅ may be, for example, in a range of about 50:50 to about 90:10. In addition, an inorganic solid electrolyte prepared by adding at least one of Li₃PO₄, a halogen, a halogen compound, Li₂₊₂ₓZn₁₋ₓGeO₄ (“LISICON”, 0≤x<1), Li_{3+y}PO₄₋ₓNₓ (“LIPON”, 0<x<4, 0<y<3), Li_{3.25}Ge_{0.25}P_{0.75}S₄ (“ThioLISICON”), Li₂O—Al₂O₃—TiO₂—P₂O₅ (“LATP”) or the like, to an inorganic solid electrolyte of at least one of Li₂S—P₂S₅, SiS₂, GeS₂, B₂S₃, or a combination thereof, may be used as the sulfide solid electrolyte. Non-limiting examples of a sulfide solid electrolyte material include at least one of Li₂S—P₂S₅, Li₂S—P₂S₅—LiX (X=halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZmSn (0<m<10, 0<n<10, Z═Ge, Zn or Ga), Li₂S—GeS₂, Li₂S—SiS₂—Li₃PO₄, and Li₂S—SiS₂—LiₚMO_{q} (0<p<10, 0<q<10, M=P, Si, Ge, B, Al, Ga or In). In this regard, a sulfide-based solid electrolyte material may be prepared by processing a raw starting material of a sulfide-based solid electrolyte material (for example, Li₂S, P₂S₅, and the like) by a melt quenching method, a mechanical milling method, or the like.

In addition, a calcination process may be performed after the processing. A sulfide-based solid electrolyte may be amorphous, crystalline, or a mixture thereof.

A polymer solid electrolyte is or includes, for example, an electrolyte including a mixture of a lithium salt and a polymer, or including a polymer having an ion conductive functional group. A polymer solid electrolyte is or includes, for example, a polymer electrolyte that does not include a liquid electrolyte. A polymer included in a polymer solid electrolyte may be or include, for example, at least one of polyethylene oxide (PEO), polyvinylidene fluoride (PVDF), vinylidene fluoride-hexafluoropropylene (PVDF-HFP), polyethylene oxide (PEO), poly(styrene-b-ethylene oxide) block copolymer (PS-PEO), poly(styrene-butadiene), poly(styrene-isoprene-styrene), poly(styrene-b-divinylbenzene) block copolymer, poly(styrene-ethylene oxide-styrene) block copolymer, polystyrene sulfonate (PSS), polyvinyl fluoride (PVF), poly(methylmethacrylate) (PMMA), polyethylene glycol (PEG), polyacrylonitrile (PAN), polytetrafluoroethylene (PTFE), polyethylenedioxythiophene (PEDOT), polypyrrole (PPY), polyaniline, polyacetylene, Nafion, Aquivion, Flemion, Gore, Aciplex, Morgane ADP, sulfonated poly(ether ether ketone) (SPEEK), sulfonated poly(arylene ether ketone ketone sulfone) (SPAEKKS), sulfonated poly(aryl ether ketone) (SPAEK), poly[bis(benzimidazobenzisoquinolinones)] (SPBIBI), poly(styrene sulfonate) (PSS), lithium 9,10-diphenylanthracene-2-sulfonate (DPASLi+), or a combination thereof, but is not limited to these, and any material that is used as a polymer electrolyte in the art may be used. A lithium salt may be or include any material that may be used as a lithium salt in the art. A lithium salt is, for example, at least one of LIDFOB, LiTFSI, LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂) (C_{y}F_{2y+1}SO₂) (x and y are each an integer in a range from 1 to 20), LiCl, LiI, or a mixture thereof.

A gel electrolyte is or includes, for example, a gel polymer electrolyte. A gel polymer electrolyte is, for example, an electrolyte including a liquid electrolyte and a polymer, or including an organic solvent and a polymer having an ion conductive functional group. A liquid electrolyte may be or include, for example, an ionic liquid, a mixture of a lithium salt and an organic solvent, a mixture of an ionic liquid and an organic solvent, or a mixture of a lithium salt, an ionic liquid, and an organic solvent. A polymer may be or include polymers used in a solid polymer electrolyte. An organic solvent may be or include organic solvents used in a liquid electrolyte. A lithium salt may be or include salts used in a solid polymer electrolyte. An ionic liquid refers to a salt in a liquid state at room temperature or a molten salt at room temperature, which has a melting point of less than or equal to room temperature and is composed only of ions. An ionic liquid may include one or more compounds such as or including at least one of a) one or more cations such as or including at least one of ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, triazolium-based, and mixtures thereof, and b) one or more anions such as or including at least one of BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻. A gel polymer electrolyte may be formed when a polymer solid electrolyte is impregnated with an electrolytic solution in a lithium secondary battery. The gel electrolyte may further include inorganic particles.

A cross-linked polymer may be or include polymers used in a solid polymer electrolyte. A cross-linked polymer may constitute a cross-linking agent. That is, a cross-linked polymer may improve mechanical strength and chemical stability while maintaining ion conductivity of a gel electrolyte by forming a three-dimensional polymer network.

A cross-linked polymer may have a molecular weight of less than or equal to about 5,000 g/mol. A cross-linked polymer may include, for example, at least one of an acrylic monomer having 3 or more reactive functional groups, a fluorinated acrylic monomer, or a combination thereof.

A cross-linked polymer may include greater than or equal to 2 reactive double bonds in one molecule. A cross-linked polymer is a polymerization product of a cross-linkable monomer, and a cross-linkable monomer may include at least one of dipentaerythritol hexaacrylate (DPHA), trimethylolpropane trimethacrylate (TMPTMA), trimethylolpropane triacrylate (TMPTA), diethylene glycol diacrylate (DEGDA), diethylene glycol dimethacrylate (DEGDMA), triethylene glycol diacrylate (TEGDA), triethylene glycol dimethacrylate (TEGDMA), tetraethylene glycol diacrylate (TTEGDA), glycidyl methacrylate, polyethylene glycol diacrylate (PEGDA), polyethylene glycol dimethacrylate (PEGDMA), polypropylene glycol diacrylate (PPGDA), dipropylene glycol diacrylate (DPGDA), tripropylene glycol diacrylate (TPGDA), dianol diacrylate (DDA), dianol dimethacrylate (DDMA), ethoxylated trimethylolpropane triacrylate (ETPTA), acrylate-functionalized ethylene oxide, butanediol dimethacrylate, ethoxylated neopentyl glycol diacrylate (NPEOGDA), propoxylated neopentyl glycol diacrylate (NPPOGDA), pentaerythritol triacrylate (PETA), ethoxylated propoxylated trimethylolpropane triacrylate (TMPEOTA)/(TMPPOTA), propoxylated glyceryl triacrylate, tris(2-hydroxyethyl) isocyanurate triacrylate (THEICTA), pentaerythritol tetraacrylate (PETTA), dipentaerythritol pentaacrylate (DPEPA), ditrimethylol propane tetraacrylate (DTMPTTA), diglycidyl ester, acrylamide, and divinylbenzene and combinations thereof.

A cross-linkable monomer may have a weight average molecular weight in a range of about 200 to about 2,000, 200 to 1,000, or for example, 200 to 500. If (when) the weight average molecular weight is less than 200, a cross-link point density in a molecular structure of a polymer after cross-linking may be substantially high, so that the movement of a lithium salt may not be free, and if (when) the weight average molecular weight is greater than 2,000, a cross-link point density in a molecular structure of a polymer after cross-linking may be substantially low, so that an electrolyte solution blocking ability may decrease.

A gel polymer electrolyte may be formed as a polymer solid electrolyte is impregnated with an electrolyte solution in a lithium secondary battery. A gel electrolyte may further include inorganic particles.

### Lithium Secondary Battery

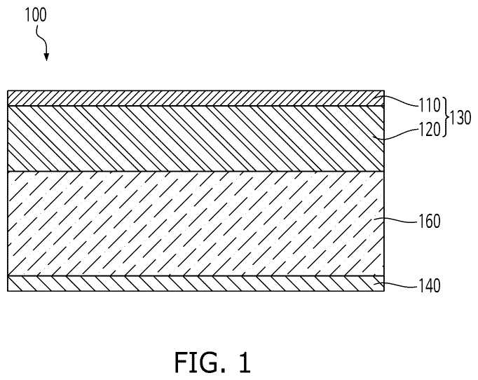

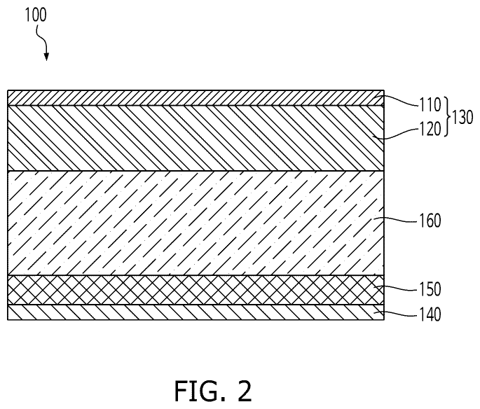

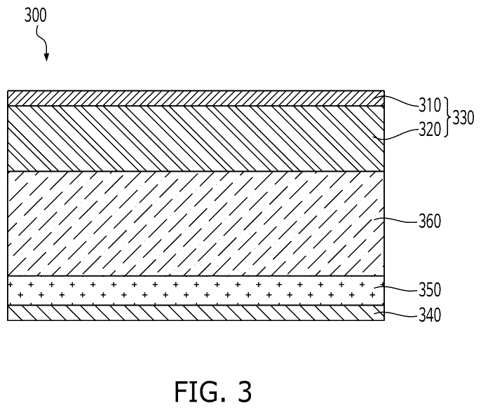

FIG. 1 is a diagram illustrating a stacked structure of a lithium secondary battery according to an example embodiment of the present disclosure. FIG. 2 is a diagram illustrating a stacked structure of the lithium secondary battery of FIG. 1 after charging. FIG. 3 is a diagram illustrating a stacked structure of a lithium secondary battery according to an example embodiment of the present disclosure.

FIG. 1 is a diagram illustrating a stacked structure of a lithium secondary battery 100 in which an anode active material layer is absent, or not plated, on an anode current collector 140, and FIG. 2 is a diagram illustrating a state in which a lithium metal is plated on the anode current collector 140 as the lithium secondary battery 100 of FIG. 1 is charged. FIG. 3 is a diagram illustrating a lithium secondary battery 300 further including a lithium metal layer 350 disposed between an anode current collector 340 and an electrolyte 360. A thickness of each layer shown in FIGS. 1 to 3 is an arbitrary size and is not necessarily limited thereto.

Referring to FIGS. 1 to 3, a lithium secondary battery 100, 300 according to an example embodiment of the present disclosure may include a cathode 130, 330 for a lithium secondary battery, an anode including an anode current collector 140, 340, a separator (not illustrated) disposed between the cathode 130, 330 and the anode, and an electrolyte 160, 360 disposed between the cathode 130, 330 and the anode. A cathode 130, 330 may include a cathode current collector 110, 310 and a cathode mixture layer 120, 320 disposed on the cathode current collector 110, 310. An electrolyte 160, 360 may include a cross-linked polymer and a liquid electrolyte.

Referring to FIGS. 1 and 2, a lithium secondary battery 100 according to an example embodiment of the present disclosure may have an anode active material layer absent, or not plated, on an anode current collector 140. A lithium secondary battery 100 according to an example embodiment may have a lithium metal layer 150 formed on the anode current collector 140 after charging is performed. The lithium metal layer 150 may be disposed between the anode current collector 140 and the electrolyte 160. For example, the lithium metal layer 150 may be or include a lithium electroplating layer.

Referring to FIG. 3, a lithium secondary battery 300 according to an example embodiment of the present disclosure may further include a lithium metal layer 350 disposed between the anode current collector 340 and the electrolyte 360. For example, a lithium secondary battery 300 may include an anode current collector 340, a lithium metal layer 350 disposed on the anode current collector 340, a cathode 130, and an electrolyte 360 disposed between the cathode 130 and the lithium metal layer 350.

A lithium metal layer 350 may include a lithium metal or a lithium alloy. The lithium metal layer 350 may be dissociated into a lithium ion and a metal cation during a discharging process, and a thickness of the lithium metal layer 350 may be reduced. The lithium metal layer 350 may have its thickness increased as a lithium ion is electroplated during a charging process.

Referring to FIGS. 1 to 3, a lithium secondary battery 100, 300 including an electrolyte 160, 360 may further include a protective layer (not illustrated) disposed between an anode and an electrolyte 160, 360. For example, a protective layer may be formed between an anode current collector 140, 340 and an electrolyte 160, 360. Alternatively, a protective layer may be formed between a lithium metal layer 150, 350 and an electrolyte 360. According to an example embodiment, a protective layer of a lithium secondary battery 100, 300 includes an inorganic oxide, and an electrolyte 160, 360 may be disposed between the protective layer and a cathode 130, 330.

According to an example embodiment, a stacked structure of a lithium secondary battery 100, 300 as described above may be stacked or wound one or more times and housed in a case, and the case may be classified into a cylindrical type, a prismatic type, a pouch type, a coin type, a pin type, and the like.

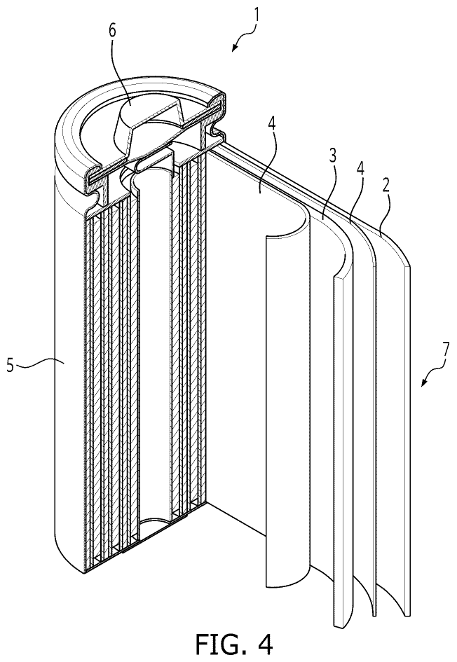

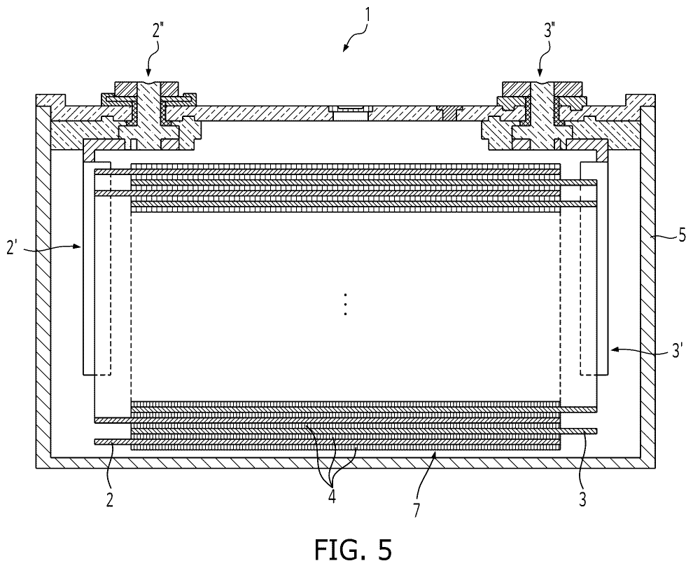

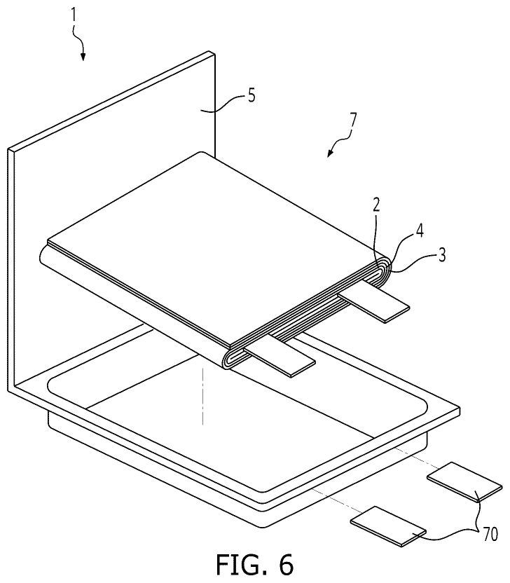

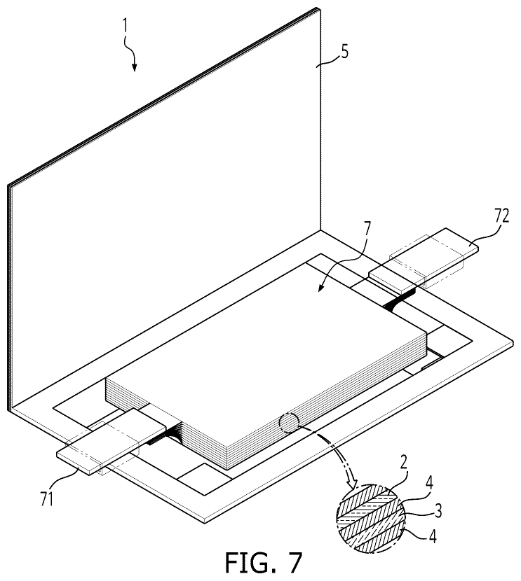

FIGS. 4 to 7 are diagrams illustrating a lithium secondary battery according to an example embodiment, and FIG. 4 is a cylindrical type, FIG. 5 is a prismatic type, and FIGS. 6 and 7 are pouch-type batteries. Referring to FIGS. 4 to 7, a lithium secondary battery 1 includes a battery structure 7 (electrode assembly) with a separator 4 (separation membrane) interposed between a cathode 3 and an anode 2, and a case 5 in which the battery structure 7 is built. The cathode 3, the anode 2, and the separator 4 may be impregnated with an electrolyte (not illustrated). A lithium secondary battery 1 may include an assembly 6 (sealing member) that seals the case 5 as shown in FIG. 4. In addition, in FIG. 5, a lithium secondary battery 1 may include a cathode lead tab 3′ and a cathode terminal 3″ connected to the cathode lead tab 3′, an anode lead tab 2′ and an anode terminal 2″ connected to the anode lead tab 2′. As shown in FIGS. 6 and 7, a lithium secondary battery 1 may include an electrode tab 70, or a cathode tab 71 and an anode tab 72, the electrode tabs 70/71/72 forming an electric path for guiding a current formed in the battery structure 7 to the outside of the battery 1.

Referring to FIG. 4, a lithium secondary battery 1 according to an example embodiment includes the cathode 3, the anode 2, and the separator 4. The cathode 3, the anode 2, and the separator 4 are wound or folded to form a battery structure 7. The formed battery structure 7 is housed in a case 5. An electrolyte is injected into the case 5 and sealed with a cap assembly 6 to complete a lithium secondary battery 1. The case 5 is cylindrical but is not necessarily limited to this shape, and may be or include, for example, a prismatic type, a pouch type, or the like.

Referring to FIG. 5, a lithium secondary battery 1 according to an example embodiment includes a cathode 3, an anode 2 as described above, and a separator 4. The cathode 3, the anode 2, and the separator 4 are wound, folded, or stacked to form a battery structure 7. The formed battery structure 7 is housed in a case 5. An electrolyte is injected into the case 5, cross-linked, and sealed to complete a lithium secondary battery 1. The case 5 is prismatic but is not necessarily limited to this shape, and may be, for example, a cylindrical type, a pouch type, or the like. A cathode lead tab 3′ and a cathode terminal 3″ are electrically connected to the cathode 3. An anode lead tab 2′ and an anode terminal 2″ are electrically connected to the anode 2.

Referring to FIG. 6, a lithium secondary battery 1 according to an example embodiment includes a cathode 3, an anode 2 as described above, and a separator 4. A separator 4 is disposed between the cathode 3 and the anode 2, and the cathode 3, the anode 2, and the separator 4 are wound or folded to form a battery structure 7. The formed battery structure 7 is housed in a case 5. The lithium secondary battery 1 may include an electrode tab 70 serving as an electrical path for guiding a current formed in the battery structure 7 to the outside of the battery 1. An electrolyte is injected into the case 5 and sealed to complete a lithium secondary battery 1. The case 5 is prismatic but is not necessarily limited to this shape and may be, for example, a cylindrical type, a thin-film type, or the like.

Referring to FIG. 7, a lithium secondary battery 1 according to an example embodiment includes a cathode 3, an anode 2 as described above, and a separator 4. The electrolyte as described above including the separator 4 is disposed between the cathode 3 and the anode 2 to form a battery structure. For example, a battery structure 7 is stacked in a bi-cell structure and then housed in a case 5. The lithium secondary battery 1 may include a cathode tab 71 and an anode tab 72, which constitute an electric path for guiding a current formed in the battery structure 7 to the outside of the battery 1. An electrolyte is injected into the case 5 and sealed to complete a lithium secondary battery 1. The case 5 is not necessarily limited to a prismatic shape and may be, for example, a cylindrical type, a pouch type, or the like.

For example, the present disclosure is not limited to the above configurations, and the case 5 may be configured in various shapes such as, e.g., a circular shape or a pouch shape. For example, a pouch-type lithium secondary battery corresponds to a case 5 using a pouch in the lithium secondary battery 1 of FIGS. 4 to 7, respectively. A pouch-type lithium secondary battery includes one or more battery structures 7. A separator 4 is disposed between a cathode 3 and an anode 2 to form a battery structure 7. The battery structure 7 is stacked in a bi-cell structure, then impregnated with an electrolyte, and housed and sealed in a pouch to complete a pouch-type lithium secondary battery.

For example, a battery structure 7 including the cathode 3, the anode 2, and the separator 4 as described above is simply stacked and housed in a pouch, or is wound or folded in a jelly-roll shape, and then housed in a pouch. Subsequently, an electrolyte is injected into the pouch and sealed to complete a lithium secondary battery 1.

A case 5 may be made of or include a metal such as aluminum, an aluminum alloy, or nickel-plated steel, or a laminate film or plastic that constitutes a pouch.

A lithium secondary battery 1 has desired or improved life characteristics and high-rate characteristics, and may be used, for example, in an electric vehicle (EV). For example, a lithium secondary battery 1 is used in a hybrid vehicle such as, e.g., a plug-in hybrid electric vehicle (PHEV). In addition, a lithium secondary battery 1 is used in fields requiring a large amount of power storage. For example, a lithium secondary battery 1 is used in an electric bicycle, a power tool, or the like.

A plurality of lithium secondary batteries 1 are stacked to form a battery module, and a plurality of battery modules form a battery pack. The battery pack may be used in all devices requiring high capacity and high output. For example, a battery pack may be used in, e.g., a laptop, a smartphone, an electric vehicle, or the like. A battery module includes, for example, a plurality of batteries and a frame for holding the batteries.

A battery pack includes, for example, a plurality of battery modules and a bus bar connecting the battery modules. A battery module and/or a battery pack may further include a cooling device. A plurality of battery packs are controlled by a battery management system. A battery management system includes a battery pack, and a battery control device connected to the battery pack.

### Anode: Anode Current Collector

Referring to FIGS. 1 to 3, an anode current collector 140, 340 may not include an anode active material layer. An anode current collector 140, 340 that does not include an anode active material layer may have a lithium metal plated on the anode current collector 140, 340 by charging. A plated metal layer may include at least one of plated lithium, a lithium metal foil, a lithium metal powder, a lithium alloy foil, a lithium alloy powder, a lithium-containing organic compound, or a combination thereof. A lithium metal layer 150 may include at least one of non-fibrous lithium, non-acicular lithium, plate-like lithium, or any combination thereof. A lithium alloy includes lithium and a first metal, and the first metal may include at least one of indium (In), silicon (Si), gallium (Ga), tin (Sn), aluminum (Al), titanium (Ti), zirconium (Zr), niobium (Nb), germanium (Ge), antimony (Sb), bismuth (Bi), gold (Au), platinum (Pt), palladium (Pd), magnesium (Mg), silver (Ag), zinc (Zn), nickel, iron, cobalt, chromium, cesium, sodium, potassium, calcium, yttrium, tantalum, hafnium, barium, vanadium, strontium, lanthanum, or a combination thereof.

Referring to FIGS. 1 to 3, a material constituting an anode current collector 140, 340 may be any material that is not reactive with lithium, that is, any material that does not form an alloy or a compound with lithium, and that has conductivity. A metal substrate is, for example, a metal or an alloy. A metal substrate may be made of or include, for example, at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof. An electrode current collector may be in the form of any one of a sheet, a foil, a film, a plate-like body, a porous body, a mesoporous body, a through-hole-containing body, a polygonal ring body, a mesh body, a foam, and a non-woven fabric body, but is not necessarily limited to these forms, and any form used in the art may be used.

An anode current collector 140, 340 may include, for example, a first metal substrate. A first metal substrate includes a first metal as a main component, or is made of or include a first metal. A content of a first metal included in a first metal substrate is, for example, greater than or equal to 90 wt %, greater than or equal to 95 wt %, greater than or equal to 99 wt %, or greater than or equal to 99.9 wt % based on a total weight of the first metal substrate. A first metal substrate may be made of or include a material that is not reactive with lithium, that is, a material that does not form an alloy and/or a compound with lithium.

A first metal is or includes, for example, at least one of copper (Cu), nickel (Ni), stainless steel (SUS), iron (Fe), cobalt (Co), or the like, but is not necessarily limited to these metals, and any material used as a current collector in the art may be used. A first metal substrate may be made of or include, for example, one of the above-mentioned metals, or an alloy of two or more of the above metals. A first metal substrate is or includes, for example, a sheet or a foil.

An anode current collector 140, 340 may further include a coating layer (not illustrated) including a second metal on a first metal substrate.

An anode current collector 140, 340 may include, for example, a first metal substrate and a coating layer disposed on the first metal substrate and including a second metal. The second metal has a higher Mohs hardness than the first metal. That is, because the coating layer including the second metal is harder than the substrate including the first metal, degradation of the first metal substrate may be reduced or prevented. A Mohs hardness of a material constituting a first metal substrate is, for example, less than or equal to about 5.5. A Mohs hardness of a first metal is, for example, less than or equal to about 5.5, less than or equal to 5.0, less than or equal to 4.5, less than or equal to 4.0, less than or equal to 3.5, or less than or equal to 3.0. A Mohs hardness of a first metal may be, for example, in a range of about 2.0-6.0. A coating layer includes a second metal. A coating layer is, for example, a coating layer including a second metal as a main component or made of or include a second metal. A content of a second metal included in a coating layer is, for example, greater than or equal to about 90 wt %, greater than or equal to 95 wt %, greater than or equal to 99 wt %, or greater than or equal to 99.9 wt % based on a total weight of the coating layer. A coating layer may be made of or include a material that is not reactive with lithium, that is, a material that does not form an alloy and/or a compound with lithium. A Mohs hardness of a material constituting a coating layer is, for example, greater than or equal to about 6.0. For example, a Mohs hardness of a second metal is greater than or equal to about 6.0, greater than or equal to 6.5, greater than or equal to 7.0, greater than or equal to 7.5, greater than or equal to 8.0, greater than or equal to 8.5, or greater than or equal to 9.0. A Mohs hardness of a second metal may be, for example, in a range of about 6.0-12. If (when) a Mohs hardness of a second metal is substantially low, it may be difficult to reduce or suppress degradation of an anode current collector. If (when) a Mohs hardness of a second metal is substantially high, processing may not be easy. A second metal is, for example, at least one or more of titanium (Ti), manganese (Mn), niobium (Nb), tantalum (Ta), iridium (Ir), vanadium (V), rhenium (Re), osmium (Os), tungsten (W), chromium (Cr), boron (B), ruthenium (Ru), and rhodium (Rh). A coating layer may be made of or include, for example, one of the above-mentioned metals, or an alloy of two or more metals. A difference in Mohs hardness between a first metal included in a first metal substrate and a second metal included in a coating layer may be, for example, greater than or equal to about 2, greater than or equal to 2.5, greater than or equal to 3, greater than or equal to 3.5, or greater than or equal to 4. As a first metal and a second metal have such a difference in Mohs hardness, degradation of an anode current collector may be reduced or suppressed more effectively. A coating layer may have a single-layer structure, or a multilayer structure of two or more layers. A coating layer may have, for example, a two-layer structure including a first coating layer and a second coating layer. A coating layer may have, for example, a three-layer structure of a first coating layer, a second coating layer, and a third coating layer. A thickness of a coating layer is, for example, in a range of about 10 nm to 1 μm, 50 nm to 500 nm, 50 nm to 200 nm, or 50 nm to 150 nm. A coating layer may be disposed on a first metal substrate by, for example, a vacuum deposition method, a sputtering method, a plating method, or the like, but is not necessarily limited to these methods, and any method that may form a coating layer in the art may be used.

For example, an anode current collector 140, 340 may have a reduced thickness compared to a conventional anode current collector. Accordingly, an anode according to the present disclosure is distinguished from a conventional electrode including a thick-film current collector by including, for example, a thin-film current collector.

As a result, energy density of a lithium-metal secondary battery adopting the electrode is increased. A thickness of an anode current collector 140, 340 is, for example, less than about 15 μm, less than or equal to 14.5 μm, or less than or equal to 14 μm. A thickness of an anode current collector 140, 340 is, for example, in a range of about 0.1 μm-15 μm, 1 μm-14.5 μm, 2 μm-14 μm, 3 μm-14 μm, 5 μm-14 μm, or 10 μm-14 μm.

An anode current collector 140, 340 may have a form such as any one of a sheet, a foil, a film, a plate-like body, a porous body, a mesoporous body, a through-hole-containing body, a polygonal ring body, a mesh body, a foam, and a non-woven fabric body, but is not necessarily limited to these forms, and any form used in the art may be used.

An anode current collector 140, 340 may include, for example, a base film and a metal substrate layer disposed on one surface, or on both surfaces, of the base film. An anode current collector includes a substrate, and the substrate may have a structure including, for example, a base film and a metal substrate layer disposed on one surface, or on both surfaces, of the base film. An intermediate layer may be additionally disposed on the metal substrate layer.

A base film may include, for example, a polymer. The polymer may be or include, for example, a thermoplastic polymer. The polymer may include, for example, at least one of polyethylene terephthalate (PET), polyethylene (PE), polypropylene (PP), polybutylene terephthalate (PBT), polyimide (PI), or a combination thereof. By including a thermoplastic polymer, the base film may melt when a short circuit occurs, thereby reducing or suppressing a sharp increase in current. A base film may be or include, for example, an insulator.

A metal substrate layer may include, for example, at least one of copper (Cu), stainless steel, titanium (Ti), iron (Fe), cobalt (Co), nickel (Ni), or an alloy thereof. A metal substrate layer may constitute an electrochemical fuse to be cut off during an overcurrent, thereby performing a short circuit reduction or prevention function. A thickness of a metal substrate layer may be determined to control a limit current and a maximum current. A metal substrate layer may be plated or deposited on a base film. If (when) a thickness of a metal substrate layer becomes thin, a limit current and/or a maximum current of an anode current collector are reduced, so that stability of a lithium-metal secondary battery during a short circuit may be improved.

A lead tab may be additionally added to a portion on a metal substrate layer for connection with the outside. A lead tab may be welded to a metal substrate layer or a metal substrate layer/base film laminate by ultrasonic welding, laser welding, spot welding, or the like. During welding, the base film and/or the metal substrate layer may melt, and the metal substrate layer may be electrically connected to the lead tab. To make the welding of the metal substrate layer and the lead tab more solid, a metal chip may be added between the metal substrate layer and the lead tab. The metal chip may be or include a thin piece of the same material as the metal of the metal substrate layer. The metal chip may be or include, for example, a metal foil, a metal mesh, or the like. A metal chip may be or include, for example, at least one of an aluminum foil, a copper foil, a SUS foil, or the like. By disposing a metal chip on a metal substrate layer, and then welding the metal chip and the lead tab, the lead tab may be welded to a metal chip/metal substrate layer laminate or a metal chip/metal substrate layer/base film laminate. During welding, the base film, the metal layer, and/or the metal chip may melt, and the metal layer or the metal layer/metal chip laminate may be electrically connected to the lead tab. A metal chip and/or a lead tab may be added to a portion on the metal substrate layer. A thickness of a base film is, for example, in a range of about 1 μm-50 μm, 1.5 μm-50 μm, 1.5 μm-40 μm, or 1 μm-30 μm. By having a thickness of the base film in this range, a weight of an anode assembly may be reduced more effectively. A melting point of a base film is, for example, in a range of about 100 degrees Celsius-300 degrees Celsius, 100 degrees Celsius-250 degrees Celsius, or 100 degrees Celsius-200 degrees Celsius. By having a melting point of the base film in this range, the base film may melt during a process of welding a lead tab and be readily bonded to the lead tab. A surface treatment such as a corona treatment may be performed on a base film to improve adhesion between the base film and a metal substrate layer. A thickness of a metal substrate layer is, for example, in a range of about 0.01 μm-3 μm, 0.1 μm-3 μm, 0.1 μm-2 μm, or 0.1 μm-1 μm. By having a thickness of a metal substrate layer in this range, stability of an anode may be secured while maintaining conductivity. A thickness of a metal chip is, for example, in a range of about 2 μm-10 μm, 2 μm-7 μm, or 4 μm-6 μm. By having a thickness of a metal chip in this range, a connection between a metal layer and a lead tab may be performed more readily. By having an anode current collector 140, 340 with this structure, a weight of an electrode may be reduced, and as a result, energy density may be improved.

Referring to FIG. 1, an anode active material layer may be free on an anode current collector 140 before charging and discharging are performed. Alternatively, a ratio of an electrical capacity of an anode to an electrical capacity of a cathode may be less than about 1 before charging and discharging are performed.

Referring to FIG. 3, a lithium metal layer 350 including a plate-like lithium metal thin film may be disposed on an anode current collector 340 before charging and discharging are performed. According to an example embodiment, an anode may further include an interlayer disposed between an anode current collector 340 and a lithium metal layer 350.

According to an example embodiment, an interlayer may be disposed, for example, directly on one surface, or on both surfaces, of an anode current collector 340. Therefore, another layer may not be disposed between an anode current collector 340 and an interlayer. By disposing an interlayer directly on one surface, or on both surfaces, of an anode current collector 340, adhesion between the anode current collector 340 and a lithium metal layer 350 may be further improved.

A thickness of an interlayer (not illustrated) may be, for example, less than or equal to about 30% of a thickness of an anode current collector 340. A thickness of an interlayer (not illustrated) is, for example, in a range of about 0.01%-30%, 0.1%-30%, 0.5%-30%, 1%-25%, 1%-20%, 1%-15%, 1%-10%, 1%-5%, or 1%-3% of a thickness of an anode current collector 340. A thickness of an interlayer is, for example, in a range of about 10 nm-5 μm, 50 nm-5 μm, 200 nm-4 μm, 500 nm-3 μm, 500 nm-2 μm, 500 nm-1.5 μm, or 700 nm-1.3μ m.

By having a thickness of an interlayer in the above ranges, adhesion between an anode current collector 340 and a lithium metal layer 350 may be further improved, and an increase in interfacial resistance may be reduced or suppressed.

For example, an interlayer may include a binder. By including a binder, an interlayer may further improve adhesion between an anode current collector 340 and a lithium metal layer 350. A binder included in an interlayer is, for example, a conductive binder or a non-conductive binder.

A conductive binder is, for example, an ion conductive binder and/or an electron conductive binder. A binder that has both ion conductivity and electron conductivity may belong to both an ion conductive binder and an electron conductive binder.

An ion conductive binder is or includes, for example, at least one of polystyrene sulfonate (PSS), polyvinylidene fluoride-hexafluoropropylene copolymer (PVDF-HFP), polyvinyl fluoride (PVF), polyvinylidene fluoride (PVDF), poly(methyl methacrylate) (PMMA), polyethylene oxide (PEO), polyethylene glycol (PEG), polytetrafluoroethylene (PTFE), polyethylenedioxythiophene (PEDOT), polypyrrole (PPY), polyacrylonitrile (PAN), polyaniline, polyacetylene, and the like. An ion conductive binder may include a polar functional group. An ion conductive binder including a polar functional group is or includes, for example, at least one of Nafion, Aquivion, Flemion, Gore, Aciplex, Morgane ADP, sulfonated poly(ether ether ketone) (SPEEK), sulfonated poly(arylene ether ketone ketone sulfone) (SPAEKKS), sulfonated poly(aryl ether ketone) (SPAEK), poly[bis(benzimidazobenzisoquinolinones)] (SPBIBI), poly(styrene sulfonate) (PSS), and lithium 9,10-diphenylanthracene-2-sulfonate (DPASLi+). An electron conductive binder is or includes, for example, at least one of polyacetylene, polythiophene, polypyrrole, poly(p-phenylene), polyphenylene vinylene, poly(phenylene sulfide), polyaniline, and the like. An interlayer may be or include, for example, a conductive layer including a conductive polymer.

A binder included in an interlayer may be or include, for example, a fluorine-based binder. A fluorine-based binder included in an interlayer may be or include, for example, polyvinylidene fluoride (PVDF). An interlayer may be disposed on an anode current collector 340 by, for example, a dry method or a wet method. An interlayer may be or include, for example, an adhesion layer including a binder.

An interlayer may additionally include a carbon-based conductive material. By including a carbon-based conductive material, an interlayer may be or include, for example, a conductive layer. An interlayer may be or include, for example, a conductive layer including a binder and a carbon-based conductive material.

An interlayer may be disposed on an anode current collector by a dry method such as, e.g., chemical vapor deposition (CVD) or physical vapor deposition (PVD). An interlayer may be disposed on an anode current collector 340 by a wet method such as, e.g., spin coating or dip coating. An interlayer may be disposed on an anode current collector 340 by depositing a carbon-based conductive material on the anode current collector 340. A dry-coated interlayer may be made of or include a carbon-based conductive material, and may not include a binder. Alternatively, an interlayer may be disposed on an anode current collector 340 by coating a composition including a carbon-based conductive material, a binder, and a solvent on a surface of the anode current collector 340, and drying the composition. An interlayer may be or include a single-layer structure or a multilayer structure including a plurality of layers.

### Anode: Lithium Metal Layer

Referring to FIGS. 1 to 3, a lithium secondary battery 100, 300 may further include a lithium metal layer 150, 350 disposed between an anode current collector 140, 340 and an electrolyte 160, 360. For example, a lithium metal layer 150, 350 may include a lithium metal or a lithium alloy. For example, a lithium metal layer 150, 350 may be or include an anode active material layer. For example, a lithium metal layer 150, 350 may be or include a lithium electroplating layer.

For example, a lithium metal layer 150, 350 may be generated as a lithium ion included in an electrolyte 360 is electroplated on an anode current collector 140, 340 as a lithium secondary battery is charged. For example, a lithium metal layer 150, 350 may include a lithium alloy and a lithium metal. For example, a lithium alloy included in a lithium metal layer 150, 350 may weaken the reactivity of a lithium metal, thereby effectively reducing or preventing a side reaction of the lithium metal layer 150, 350 and an electrolyte 360. In addition, a lithium metal layer 150, 350 has desired or improved electrical conductivity, and an internal resistance of a lithium secondary battery 100, 300 including the lithium metal layer 150, 350 may be reduced. Accordingly, a lithium secondary battery 100, 300 including a lithium metal layer 150, 350 may have not only the life characteristics thereof, but also the charging and discharging efficiency thereof improved.

According to an example embodiment, a lithium metal layer 150, 350 may include, for example, at least one of a lithium foil, a lithium powder, plated lithium, a carbon-based material, or a combination thereof. For example, a lithium metal layer 150, 350 may include a lithium foil. In this case, a lithium metal layer 150, 350 may be or include an anode active material layer. For example, a lithium metal layer 150, 350 may be introduced by coating a slurry including a lithium powder and a binder, or the like, on an anode current collector. For example, a binder may be or include a fluorine-based binder such as polyvinylidene fluoride (PVDF).

According to an example embodiment, a lithium metal layer 150, 350 may include only a plated lithium metal or a lithium alloy. In this case, a lithium metal layer 150, 350 may be or include a lithium electroplating layer.

According to an example embodiment, a lithium metal layer 150, 350 may not include a carbon-based anode active material. Therefore, a lithium metal layer 150, 350 may be made of or include a metal-based anode active material.

For example, a thickness of a lithium metal layer 150, 350 may be, for example, in a range of about 0.1 μm-100 μm, 0.1 μm-80 μm, 1 μm-80 μm, or 10 μm-80 μm, but is not necessarily limited to this range and may be adjusted according to a desired shape, capacity, and the like, of a lithium secondary battery 100, 300. If (when) a thickness of a lithium metal layer 150, 350 is substantially increased, e.g., above about 100 μm, structural stability of a lithium secondary battery 100, 300 may be lowered, and a side reaction may be increased. If (when) a thickness of a lithium metal layer 150, 350 is substantially small, e.g., below about 0.1 μm, energy density of a lithium metal secondary battery may be lowered.

According to an example embodiment, a thickness of a lithium foil included in a lithium metal layer 150, 350 may be, for example, in a range of about 1 μm-50 μm, 1 μm-30 μm, or 10 μm-30 μm, or 10 μm-80 μm. By having a thickness of a lithium foil in this range, life characteristics of a lithium secondary battery 100, 300 may be further improved.

According to an example embodiment, a particle diameter of a lithium powder included in a lithium metal layer 150, 350 may be, for example, in a range of about 0.1 μm-3 μm, 0.1 μm-2 μm, or 0.1 μm-1 μm. By having a particle diameter of a lithium powder in this range, life characteristics of a lithium secondary battery 100, 300 may be further improved.

### Cathode

Referring to FIGS. 1 to 3, a cathode mixture layer 120, 320 is disposed on a cathode current collector 110, 310 to form a cathode 130, 330.

### Cathode: Cathode Current Collector

Referring to FIGS. 1 to 3, a cathode 130, 330 includes a cathode current collector 110, 310.

A cathode current collector 110, 310 may include, for example, at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

According to an example embodiment, a cathode current collector 110, 310 may include aluminum (Al). According to an example embodiment, a cathode current collector 110, 310 may include a base film, and a metal layer disposed on one surface, or on both surfaces, of the base film, in the same manner as the anode current collector 140, 340 as described above.

### Cathode: Cathode Mixture Layer

A cathode mixture layer 120, 320 may include a cathode active material. A cathode mixture layer 120, 320 may further include a conductive material and/or a binder.

As a cathode active material, a compound capable of reversible intercalation and deintercalation of lithium (a lithiated intercalation compound) may be used. For example, one or more complex oxides of a metal such as or including at least one of cobalt, manganese, nickel, and a combination thereof and lithium, may be used. The complex oxide may be or include a lithium transition metal complex oxide. For example, at least one of a lithium nickel-based oxide, a lithium cobalt-based oxide, a lithium manganese-based oxide, a lithium iron phosphate-based compound, a cobalt-free nickel-manganese-based oxide, or a combination thereof may be used.

As an example, a cathode active material may include at least one of LiMO₂ (Mis or includes at least one of Al, Ni, Co, Mn, Cr, Fe, Mg, Sr, V, a rare earth element, or a combination thereof), LFP, LMFP, LiM′₂O₄ (M′ is or includes at least one of Ti, V, Mn, or a combination thereof), or a combination thereof.

As an example, a compound represented by any one of the following chemical formulae may be used: LiₐA_{1-b}X_{b}O_{2-c}D_{c} (0.90≤a≤1.8, 0≤b≥<0.5, 0≤c≤0.05), LiₐMn_{2-b}X_{b}O_{4-c}D_{c} (0.90≤a≤1.8, 0≤b≤0.5, 0≤c≤0.05), LiₐNi_{1-b-c}CO_{b}X_{c}O_{2-α}D_{α} (0.90≤a≤1.8, 0≤b≤0.5, 0≤c≤0.5, 0<α<2), LiₐNi_{1-b-c}Mn_{b}X_{c}O_{2-α}D_{α} (0.90≤a≤1.8, 0≤b≤0.5, 0<c<0.5, 0<α<2), LiₐNi_{b}Co_{c}L¹_{d}GₑO₂ (0.90≤a≤1.8, 0≤b≤0.9, 0≤c≤0.5, 0≤d<0.5, 0≤e≤0.1), LiₐNiG_{b}O₂ (0.90≤a≤1.8, 0.001≤b≤0.1), LiₐCoG_{b}O₂ (0.90≤a≤1.8, 0.001≤b≤0.1), LiₐMn_{1-b}G_{b}O₂ (0.90≤a≤1.8, 0.001≤b≤0.1), LiₐMn₂GbO₄ (0.90≤a≤1.8, 0.001≤b≤0.1), LiₐMn_{1-g}G_{g}PO₄ (0.90≤a≤1.8, 0≤g<0.5), Li_{(3-f)}Fe₂(PO₄)₃ (0≤f≤2), LiₐFePO₄ (0.90≤a≤1.8).

In the above chemical formulae, A is or includes at least one of Ni, Co, Mn, or a combination thereof, X is or includes at least one of Al, Ni, Co, Mn, Cr, Fe, Mg, Sr, V, a rare earth element, or a combination thereof, D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

As an example, a cathode active material may be or include a high-nickel-based cathode active material in which a content of nickel based on 100 mol % of a metal excluding lithium in a lithium transition metal complex oxide is greater than or equal to 80 mol %, greater than or equal to 85 mol %, greater than or equal to 90 mol %, greater than or equal to 91 mol %, or greater than or equal to 94 mol % and less than or equal to 99 mol %. A high-nickel-based cathode active material may be applied to a high-capacity, high-density lithium secondary battery because a high capacity may be realized.

For example, a lithium transition metal oxide may be or include a compound represented by the following Chemical Formula 1.

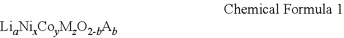

In Chemical Formula 1, 1.0≤a≤1.2, 0≤b≤0.2, 0.6≤x<1, 0≤y≤0.3, 0<z≤0.3, and x+y+z=1, M is or includes at least one of one or more of manganese (Mn), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), and boron (B), and A is or includes at least one of F, S, Cl, Br, or a combination thereof.

In Chemical Formula 1, for example, 0.7≤x<1, 0<y≤0.3, 0<z≤0.3, 0.8≤x<1, 0<y≤0.2, 0<z≤0.2, 0.83≤x<0.97, 0<y≤0.15, 0<z<0.15, or 0.85≤x<0.95, 0<y≤0.1, 0<z≤0.1.

For example, a lithium transition metal oxide may be or include at least one of compounds represented by the following Chemical Formulae 2 and 3.

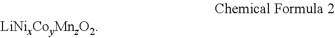

In Chemical Formula 2, 0.6≤x≤0.95, 0<y≤0.2, 0<z≤0.1 For example, 0.7≤x≤0.95, 0<y≤0.3, 0<z≤0.3.

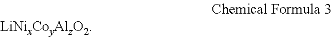

In Chemical Formula 3, 0.6≤x≤0.95, 0<y≤0.2, 0<z≤0.1. For example, 0.7≤x≤0.95, 0<y≤0.3, 0<z≤0.3. For example, 0.8≤x≤0.95, 0<y≤0.3, 0<z≤0.3 [symbol] . For example, 0.82≤x≤0.95, 0≤y≤0.15, 0<z≤0.15. For example, 0.85≤x≤0.95, 0<y≤0.1, 0<z≤0.1.

For example, a lithium transition metal oxide may be or include at least one of LiNi_{0.6}Co_{0.2}Mn_{0.2}O₂, LiNi_{0.88}Co_{0.08}Mn_{0.04}O₂, LiNi_{0.8}Co_{0.15}Mn_{0.05}O₂, LiNi_{0.8}Co_{0.1}Mn_{0.1}O₂, LiNi_{0.88}Co_{0.1}Mn_{0.02}O₂, LiNi_{0.8}Co_{0.15}Al_{0.05}O₂, LiNi_{0.8}Co_{0.1}Mn_{0.2}O₂, or LiNi_{0.88}Co_{0.1}Al_{0.02}O₂.

For example, a cathode active material may be or include a lithium transition metal oxide having a coating layer on the surface, or a mixture of a lithium transition metal oxide and a lithium transition metal oxide having a coating layer may be used.

For example, a coating layer may include a coating element compound of an oxide of a coating element, a hydroxide of a coating element, an oxyhydroxide of a coating element, an oxycarbonate of a coating element, or a hydroxycarbonate of a coating element.

For example, a compound constituting a coating layer may be amorphous or crystalline. A coating element included in a coating layer may include at least one of Mg, Al, Co, K, Na, Ca, Si, Ti, V, Sn, Ge, Ga, B, As, Zr, or a mixture thereof. A coating layer forming process may use any coating method as long as the lithium transition metal oxide can be coated using coating elements in a manner that does not adversely affect properties of the anode active material (e.g., spray coating, dipping, and the like).

As an example, a cathode may further include an additive that may constitute a sacrificial cathode.

A content of a cathode active material may be greater than or equal to about 90 wt % and less than or equal to about 99.5 wt % based on 100 wt % of a cathode mixture layer 120, 320, and a content of a binder and a conductive material may be greater than or equal to about 0.5 wt % and less than or equal to about 5 wt % each based on 100 wt % of a cathode mixture layer 120, 320.

A binder may adhere cathode active material particles to each other, and may also adhere the cathode active material to a current collector. Representative examples of a binder include at least one of polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride (PVDF), polyethylene, polypropylene, styrene-butadiene rubber, (meth)acrylated styrene-butadiene rubber, an epoxy resin, a (meth)acrylic resin, a polyester resin, nylon, and the like, but are not limited to these compounds.

A conductive material may impart conductivity to an electrode, and any electron conductive material may be used as long as the electron conductive material does not cause an adverse chemical change in a battery to be constituted. Examples of a conductive material include carbon-based materials such as at least one of natural graphite, artificial graphite, carbon black, acetylene black, ketjen black, carbon fiber, carbon nanofiber, and carbon nanotube, metal-based materials containing copper, nickel, aluminum, silver, and the like, and in the form of a metal powder or a metal fiber, a conductive polymer such as a polyphenylene derivative, or a mixture thereof.

### Separator

A lithium secondary battery according to an example embodiment may further have a separator (not illustrated).

As a separator, a multilayer film of two or more layers of polyethylene, polypropylene, polyvinylidene fluoride, or a combination thereof may be used, and a mixed multilayer film such as at least one of a polyethylene/polypropylene two-layer separator, a polyethylene/polypropylene/polyethylene three-layer separator, and a polypropylene/polyethylene/polypropylene three-layer separator may be used.

A separator may include a porous substrate and a coating layer including an organic material, an inorganic material, or a combination thereof located on one surface or both surfaces of the porous substrate.

A porous substrate may be or include a polymer membrane formed of or including at least one of a polyolefin such as polyethylene or polypropylene, a polyester such as polyethylene terephthalate or polybutylene terephthalate, a polymer such as or including at least one of polyacetal, polyamide, polyimide, polycarbonate, polyetherketone, polyaryletherketone, polyetherimide, polyamideimide, polybenzimidazole, polyethersulfone, polyphenylene oxide, a cyclic olefin copolymer, polyphenylene sulfide, polyethylene naphthalate, glass fiber, Teflon, and polytetrafluoroethylene, or a copolymer or a mixture of two or more of these compounds.

An organic material may include a polyvinylidene fluoride-based polymer, or a (meth)acrylic-based polymer.

An inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited to these compounds.

An organic material and an inorganic material may exist as a mixture in a single coating layer, or a coating layer including an organic material and a coating layer including an inorganic material may exist in a stacked form.

The following examples and comparative examples are described in more detail. However, the examples are presented for illustrative purposes and are not limited to these.

### Example 1

### Electrolyte Manufacturing:

As a liquid electrolyte, 1.0 M LiDFOB and 0.4 M LiBF₄ added to DEC/FEC (2:1 volume ratio) were used. A precursor solution was prepared by dissolving 2.5 wt % TMPTMA (trimethylolpropane trimethacrylate), 2.5 wt % HFDA (3,3,4,4,5,5,6,6,7,7,8,8,9,9,10,10,11,11,12,12,12-heneicosafluorododecyl (meth)acrylate), and 0.15 wt % of AIBN initiator in the liquid electrolyte.

Thereafter, an electrolyte was manufactured by polymerizing the precursor solution at 55 degrees Celsius for 12 hours under a pressure of 0.7 MPa.

### Cathode Preparation:

A NCA (lithium nickel cobalt aluminum oxide) cathode with a total area capacity of 4.8 mAh/cm2 was prepared.

### Anode Manufacturing:

As an anode current collector, a copper (Cu) foil with a thickness of 8 μm was prepared.

### Lithium Secondary Battery Manufacturing:

As a separator, a 17 μm PP/PE/PP triple-layer separator was used.

An anode, a separator, and a cathode were sequentially stacked to prepare an electrode assembly, and the electrolyte precursor solution as described above was injected into the electrode assembly. Thereafter, a lithium secondary battery was prepared by thermal cross-linking at 80 degrees Celsius.

### Comparative Example 1

A lithium secondary battery was prepared in the same manner as in Example 1, with a difference that a content of an acrylic monomer was used as 5 wt % and a fluoroacrylic monomer was not used, as indicated in Table 1 below.

### Comparative Example 2

A lithium secondary battery was prepared in the same manner as in Example 1, with a difference that TFEA (trifluoroethyl acrylate) was used as a fluoroacrylic monomer, as indicated in Table 1 below.

### Comparative Example 3

A lithium secondary battery was prepared in the same manner as in Example 1, with a difference that HFBA (2,2,3,4,4,4-hexafluorobutyl acrylate) was used as a fluoroacrylic monomer, as indicated in Table 1 below.

### Reference Example

A lithium secondary battery was prepared in the same manner as in Example 1, with a difference that as an electrolyte, a solution in which 1.0 M LiDFOB and 0.4 M LiBF₄ were added to DEC/FEC (2:1 volume ratio) was used, and an acrylic monomer and a fluoroacrylic monomer were not used, as indicated in Table 1 below.

TABLE 1

| | |
|---|---|
| Acrylic monomer | Fluoroacrylic monomer |

| | Type | wt % | Type | wt % |
|---|---|---|---|---|
| Example 1 | TMPTMA | 2.5 | HFDA | 2.5 |
| Comparative | TMPTMA | 5 | — | — |
| Example 1 | | | | |
| Comparative | TMPTMA | 2.5 | TFEA | 2.5 |
| Example 2 | | | | |
| Comparative | TMPTMA | 2.5 | HFBA | 2.5 |
| Example 3 | | | | |
| Reference | — | — | — | — |
| Example | | | | |

### Evaluation Example 1: Contact Angle Measurement

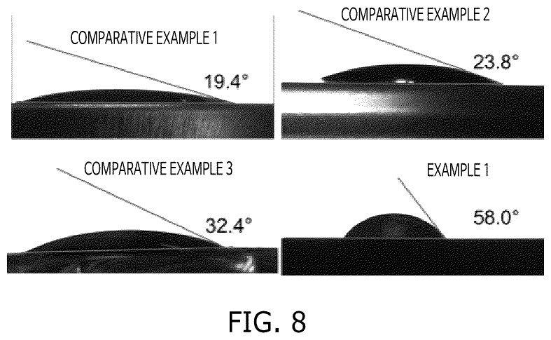

In the Example and Comparative Examples, measurements and analysis were performed using a contact angle analyzer (KRUSS DSA100) and a dedicated measurement program (ADVANCE Software). 20 μl of the electrolyte of the Reference Example was placed in the form of a drop on the electrolyte of the Example or Comparative Example, and an angle formed by the electrolyte of the Reference Example and the electrolyte of the Example or Comparative Example was measured every 1 second for 10 seconds without a delay time. In the same way, the position was changed to measure an angle formed by the electrolyte and the copolymer. The contact angle was measured at a total of 5 locations, and the result was shown as an average value. The measured images are shown in FIG. 8, and the calculation results are described in Table 1 above. Meanwhile, the measurement was set with a sessile drop orientation, an Ellipse (Tangent-1) measurement method, and a manual baseline.

FIG. 8 is an image illustrating contact angles of an electrolyte of an Example and Comparative Examples according to an evaluation example. Referring to FIG. 8, it was found that the contact angle was 58 degrees for Example 1, 19.4 degrees for Comparative Example 1, 23.8 degrees for Comparative Example 2, and 32.4 degrees for Comparative Example 3.

### Evaluation Example 2: Impedance Measurement

In the Example and Comparative Examples, a charge transfer resistance (Rct, cathode charge transport resistance) at a cathode/electrolyte interface and an anode/electrolyte interface was measured using electrochemical impedance spectroscopy (EIS) for the manufactured lithium secondary battery. Measurement results of the charge transfer resistance (Rct, cathode charge transport resistance) are shown in Table 2 below.

### Evaluation Example 3: Coulombic Efficiency Evaluation

Lithium secondary batteries manufactured according to the Example and Comparative Examples were left at a constant temperature of 25 degrees Celsius for 24 hours, and then a lithium secondary battery charger/discharger (Toyo-System Co., LTD, TOSCAT3600) was used to complete a cell formation process by charging at a constant current at a rate of 0.1 C to 4.5 V at 45 degrees Celsius, charging at a constant voltage of 4.5 V with a cut-off current of 0.05 C, and discharging at a constant current at a rate of 0.1 C to 2.0 V.

Subsequently, to check the initial capacity of the battery, the battery was charged at a constant current at a rate of 0.2 C to 4.5 V at 45 degrees Celsius, and charged at a constant voltage mode at 4.5 V with a cut-off current of 0.05 C, and then discharged at a constant current at a rate of 0.2 C to 2.0 V to check the initial capacity of the battery. During the capacity check process, the initial coulombic efficiency was calculated according to the following Formula 1 and is shown in Table 3 below. The cycle of cell formation is excluded from the following formula.

$$Initial efficiency ( \% ) = ( discharge capacity in initial capacity check cycle / charge capacity in initial capacity check cycle ) \times 100. \qquad Formula 1$$

The initial efficiency may reflect an amount of lithium irreversibly lost during a first charging process of a battery. In addition, the initial efficiency may be used as an index for evaluating the initial stability of a battery.

### Evaluation Example 5: Capacity Retention Rate Measurement

Lithium secondary batteries manufactured according to the Example and Comparative Examples were charged at a constant current at a rate of 0.1 C at 25 degrees Celsius until a voltage reached 4.5 V (vs. Li), and then was cut off at a current of 0.05 C while maintaining 4.5 V in a constant voltage mode. Subsequently, a constant current discharge was performed at a rate of 0.1 C until a cut-off voltage of 3 V (vs. Li) was reached during discharging (formation stage, 1st cycle).

This charging and discharging process was performed once to complete a formation process.

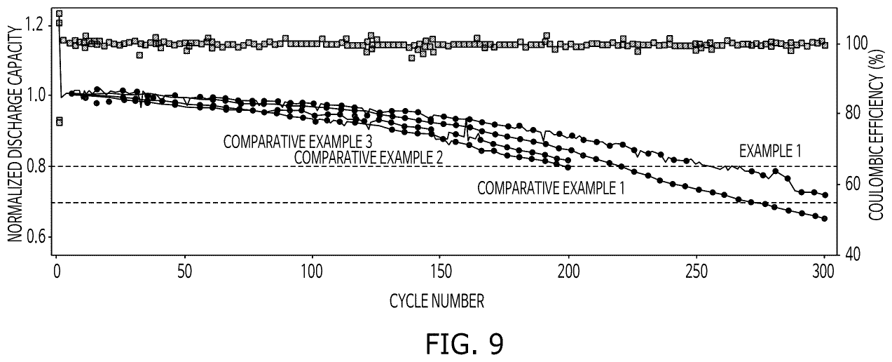

A lithium secondary battery that had undergone the formation stage was charged with a constant current of 0.33 C in a voltage range of 3-4.5 V relative to lithium metal at 25 degrees Celsius, and then was cut off at a current of 0.05 C while maintaining 4.5 V in a constant voltage mode. Subsequently, a constant current discharge was performed at 1.0 C until a cut-off voltage of 3 V was reached. The above-mentioned charging and discharging process was repeatedly performed for a total of 100 times. In all charging and discharging cycles, a rest time of 5 minutes was provided after one charging/discharging cycle. Here, a capacity retention rate at an N-th cycle is defined by the following Formula 2, and a capacity retention rate for each is shown in FIG. 9.

$$Capacity retention rate ( \% ) = ( discharge capacity at N - th cycle / discharge capacity at 1 st cycle ) \times 100. \qquad Formula 2$$

FIG. 9 is an image illustrating capacity retention rates of an Example and Comparative Examples according to an evaluation example. Referring to FIG. 9, it was found that a lithium secondary battery according to Example 1 showed a high capacity retention rate of 88.2% after 200 cycles at 25 degrees Celsius, which was higher than 81.6% of Comparative Example 1, 80.3% of Comparative Example 2, 80.1% of Comparative Example 3, and 84.6% of the Reference Example. In addition, it was found that a lithium secondary battery according to Example 1 achieved a capacity retention rate of 81.8% after 250 cycles and 72.2% after 300 cycles, which was higher than the retention rate of a lithium secondary battery according to the Reference Example, which was 73.6% after 250 cycles and 65.2% after 300 cycles.

### Evaluation Example 6: Transmission Electron Microscope (TEM)

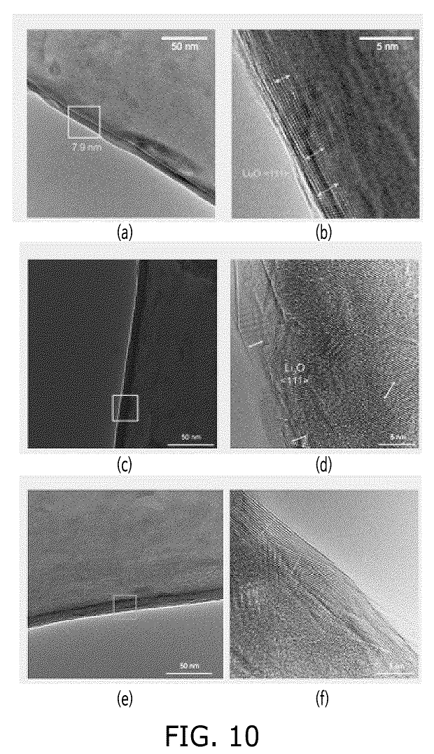

An SEI (Solid Electrolyte Interphase) formed on a surface of an anode in a lithium secondary battery manufactured according to the Example, Comparative Examples, and the Reference Example was photographed with a TEM, respectively, and is shown in FIG. 10.

FIG. 10 is an image of an SEI layer of a lithium secondary battery of an Example, Comparative Examples, and a Reference Example, photographed with a Cryo-TEM according to an evaluation example. FIG. 10(a) is a Cryogenic Transmission Electron Microscopy (Cryo-TEM) image of an SEI layer on a lithium metal deposited from an electrolyte of Example 1, and FIG. 10(b) is a Cryo-TEM image of a square portion of FIG. 10(a) magnified. FIG. 10(c) is a Cryo-TEM image of an SEI layer on a lithium metal deposited from an electrolyte of the Reference Example, and FIG. 10(d) is a Cryo-TEM image of a square portion of FIG. 10(c) magnified. FIG. 10(e) is a Cryo-TEM image of an SEI layer on a lithium metal deposited from an electrolyte of Comparative Example 1, and FIG. 10(f) is a Cryo-TEM image of a square portion of FIG. 10(e) magnified.

Referring to FIG. 10, it was confirmed that Example 1 and the Reference Example had a thin SEI layer of 8 nm to 10 nm, while Comparative Example 1 had a much thicker SEI layer of greater than or equal to 20 nm.

### Evaluation Example 7: SEM

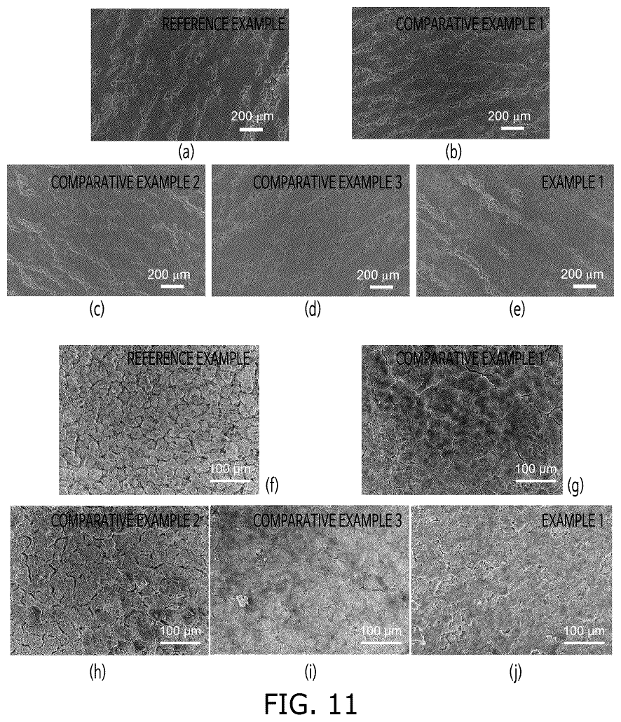

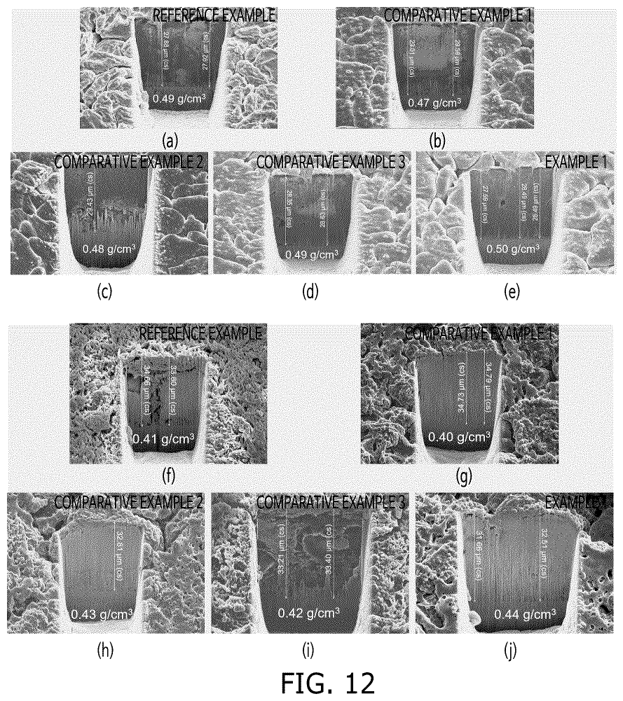

In lithium secondary batteries manufactured according to the Example, Comparative Examples, and the Reference Example, lithium metal deposited on an electrolyte at a cycle charge end point was photographed with an SEM, respectively, and is shown in FIG. 11, and a lithium metal domain size is shown in Table 4. In addition, the lithium metal was photographed with a FIB-SEM, respectively, and is shown in FIG. 12, and a density of the deposited lithium was calculated and is shown in Table 4 below.

FIG. 11 is an image of an anode surface of a lithium secondary battery of an Example, Comparative Examples, and a Reference Example, photographed with an SEM according to an evaluation example. FIG. 11(a) is an SEM image of lithium deposited on an anode of the Reference Example after a 3rd cycle charge end point, (b) is an SEM image of lithium deposited on an anode of Comparative Example 1 after a 3rd cycle charge end point, (c) is an SEM image of lithium deposited on an anode of Comparative Example 2 after a 3rd cycle charge end point, (d) is an SEM image of lithium deposited on an anode of Comparative Example 3 after a 3rd cycle charge end point, (e) is an SEM image of lithium deposited on an anode of Example 1 after a 3rd cycle charge end point, (f) is an SEM image of lithium deposited on an anode of the Reference Example after a 50th cycle charge end point, and (g) is an SEM image of lithium deposited on an anode of Comparative Example 1 after a 50th cycle charge end point. (h) is an SEM image of lithium deposited on an anode of Comparative Example 2 after a 50th cycle charge end point, (i) is an SEM image of lithium deposited on an anode of Comparative Example 3 after a 50th cycle charge end point, and (j) is an SEM image of lithium deposited on an anode of Example 1 after a 50th cycle charge end point.

FIG. 12 is an image of an anode surface of a lithium secondary battery of an Example, Comparative Examples, and a Reference Example, photographed with a Focused Ion Bean-Scanning Electron Microscopy (FIB-SEM) according to an evaluation example. FIG. 12(a) is a FIB-SEM image of lithium deposited on an anode of the Reference Example after a 3rd cycle charge end point, (b) is a FIB-SEM image of lithium deposited on an anode of Comparative Example 1 after a 3rd cycle charge end point, (c) is a FIB-SEM image of lithium deposited on an anode of Comparative Example 2 after a 3rd cycle charge end point, (d) is a FIB-SEM image of lithium deposited on an anode of Comparative Example 3 after a 3rd cycle charge end point, (e) is a FIB-SEM image of lithium deposited on an anode of Example 1 after a 3rd cycle charge end point, and (f) is a FIB-SEM image of lithium deposited on an anode of the Reference Example after a 50th cycle charge end point. (g) is a FIB-SEM image of lithium deposited on an anode of Comparative Example 1 after a 50th cycle charge end point, (h) is a FIB-SEM image of lithium deposited on an anode of Comparative Example 2 after a 50th cycle charge end point, (i) is a FIB-SEM image of lithium deposited on an anode of Comparative Example 3 after a 50th cycle charge end point, and (j) is a FIB-SEM image of lithium deposited on an anode of Example 1 after a 50th cycle charge end point.

### Evaluation Example 8: Stability Evaluation

A lithium secondary battery manufactured according to the Example, Comparative Examples, and the Reference Example was ignited with a butane torch, and whether or not the lithium secondary battery ignited was photographed. As a result of the photographing, it was confirmed that Comparative Example 1 and the Reference Example ignited readily, but Example 1 did not ignite even after continuous exposure.

A 200 mAh Cu/NCA multilayer pouch cell manufactured using an electrolyte of the Example and the Reference Example was subjected to a drilling test in a fully charged state, and a core temperature was measured. As a result of the measurement, it was confirmed that in Example 1, a core temperature rose only up to 60 degrees Celsius during drilling, and a cell voltage was recovered after the drill was removed, confirming the desired or improved safety of a pouch cell based on an electrolyte of the present disclosure. It was found that in the Reference Example, the core temperature exceeded 146 degrees Celsius and exploded during drilling, and the voltage dropped to 0 V after drilling.

### Evaluation Example 9: Initial Discharge Capacity Measurement

A 200 mAh Cu/NCA multilayer pouch cell was manufactured by using 2.8 g/Ah of the electrolyte for both the Examples and Comparative Examples and having an NCA loading of 3.1 mAh/cm². After 0.02 C formation, the cell was charged at 0.2 C and discharged at 0.5 C between 3.6 V and 4.3 V, and the initial discharge capacity was measured. As a result of the measurement, it was confirmed that Example 1 achieved a specific capacity of 152.6 mAh/g (192.1 mAh total), and a capacity retention rate after 100 cycles was 92.2%.

TABLE 2

| | R_{ct} | | |
|---|---|---|---|
| | (@50 cycle, Ω) | | |
| | Cathode/electrolyte | Anode/electrolyte | |
| | interface | interface | Total |
| Example 1 | 0.32 | 2.08 | 2.40 |
| Comparative | 0.78 | 2.81 | 3.59 |
| Example 1 | | | |
| Comparative | 0.58 | 2.58 | 3.16 |
| Example 2 | | | |
| Comparative | 0.63 | 2.71 | 3.34 |
| Example 3 | | | |
| Reference Example | 0.48 | 2.35 | 2.83 |

TABLE 3

| | Coulombic efficiency (%) |
|---|---|
| Example 1 | 99.0 |
| Comparative | 98.5 |
| Example 1 | |
| Comparative | 98.4 |
| Example 2 | |
| Comparative | 98.8 |
| Example 3 | |
| Reference Example | 98.7 |

TABLE 4

| | Lithium metal | Lithium density | Lithium density |
|---|---|---|---|
| | Domain size (μm², | (g/cm³, | (g/cm³, |
| | @3 cycle) | @3 cycle) | @50 cycle) |
| Example 1 | 38.8 | 0.50 | 0.44 |
| Comparative | 25.0 | 0.47 | 0.40 |
| Example 1 | | | |
| Comparative | 24.5 | 0.48 | 0.43 |
| Example 2 | | | |
| Comparative | 26.0 | 0.49 | 0.42 |
| Example 3 | | | |
| Reference | 29.1 | 0.49 | 0.41 |
| Example | | | |

Although an example embodiment of the present disclosure has been described above, the present disclosure is not limited thereto, and various modifications may be made within the scope of the claims, the detailed description of the disclosure, and the attached drawings, which are also within the scope of the present disclosure.

What is claimed is:

1. An electrolyte comprising:
a copolymer of an acrylic monomer; and
a fluoroacrylic monomer;
wherein the fluoroacrylic monomer comprises 7 or more fluorine atoms.

2. The electrolyte as claimed in claim 1, wherein the fluoroacrylic monomer comprises at least one of 1H,1H,2H,2H-heptadecafluorodecyl (meth)acrylate, 1H,1H,5H-octafluoropentyl (meth)acrylate, 1H,1H,2H,2H-nonafluorohexyl (meth)acrylate, 2,2,3,3,4,4,5,5,6,6,7,7-dodecafluoroheptyl (meth)acrylate, and 3,3,4,4,5,5,6,6,7,7,8,8,9,9,10,10,11,11,12,12,12-heneicosafluorododecyl (meth)acrylate.

3. The electrolyte as claimed in claim 1, wherein a weight of the fluoroacrylic monomer is greater than or equal to about 0.1 wt % and less than or equal to about 20 wt % of a weight of the electrolyte.

4. The electrolyte as claimed in claim 1, wherein a weight of the fluoroacrylic monomer is greater than or equal to about 2.0 wt % and less than or equal to about 3.0 wt % of a weight of the electrolyte.

5. The electrolyte as claimed in claim 1, wherein the acrylic monomer comprises at least one of PETTA (pentaerythritol tetraacrylate), TMPTMA (trimethylolpropane trimethacrylate), DPHA (dipentaerythritol hexaacrylate), and a combination thereof.

6. The electrolyte as claimed in claim 1, wherein a weight of the acrylic monomer is greater than or equal to about 0.1 wt % and less than or equal to about 20 wt % of a weight of the electrolyte.

7. The electrolyte as claimed in claim 1, wherein a weight of the acrylic monomer is greater than or equal to about 2.0 wt % and less than or equal to about 3.0 wt % of a weight of the electrolyte.

8. The electrolyte as claimed in claim 1, wherein a weight ratio of the fluoroacrylic monomer and the acrylic monomer is in a range of about 3:7 to about 7:3.

9. The electrolyte as claimed in claim 1, wherein a weight ratio of the fluoroacrylic monomer and the acrylic monomer is in a range of about 4:6 to about 6:4.

10. The electrolyte as claimed in claim 1, further comprising a lithium salt and an organic solvent.

11. The electrolyte as claimed in claim 10, wherein the lithium salt comprises at least one of LiPF₆, LiBF₄, LiTFSI, LiFSI, LIDFOB, LiBOB, LiClO₄, and a combination thereof.

12. The electrolyte as claimed in claim 10, wherein the organic solvent comprises a carbonate-based solvent.

13. A lithium secondary battery, comprising:
a cathode;
an anode comprising an anode current collector; and
an electrolyte disposed between the cathode and the anode,
wherein the electrolyte comprises a copolymer of an acrylic monomer and a fluoroacrylic monomer, and
wherein the fluoroacrylic monomer comprises 7 or more fluorine atoms.

14. The lithium secondary battery as claimed in claim 13, wherein the fluoroacrylic monomer comprises at least one of 1H,1H,2H,2H-heptadecafluorodecyl (meth)acrylate, 1H,1H,5H-octafluoropentyl (meth)acrylate, 1H,1H,2H,2H-nonafluorohexyl (meth)acrylate, 2,2,3,3,4,4,5,5,6,6,7,7-dodecafluoroheptyl (meth)acrylate, and 3,3,4,4,5,5,6,6,7,7,8,8,9,9,10,10,11,11,12,12,12-heneicosafluorododecyl (meth)acrylate.

15. The lithium secondary battery as claimed in claim 13, wherein a weight of the fluoroacrylic monomer is greater than or equal to about 0.1 wt % and less than or equal to about 20 wt % of a weight of the electrolyte.

16. The lithium secondary battery as claimed in claim 13, wherein the acrylic monomer comprises at least one of bisphenol A ethoxylate diacrylate, bisphenol A ethoxylate dimethacrylate, triethylene glycol diacrylate (TEGDA), triethylene glycol dimethacrylate (TEGDMA), polyethylene glycol diacrylate (PEGDA), polyethylene glycol dimethacrylate (PEGDMA), trimethylolpropane triacrylate (TMPTA), trimethylolpropane trimethacrylate (TMPTMA), pentaerythritol triacrylate (PET3A), pentaerythritol trimethacrylate (PET3MA), pentaerythritol tetraacrylate (PETTA), pentaerythritol tetramethacrylate (PETTMA), ethoxylated trimethylol propane triacrylate (EOTMPTA), propoxylated glyceryl triacrylate (PGTA), dipentaerythritol pentaacrylate (DPEPA), dipentaerythritol hexaacrylate (DPHA), and a combination thereof.

17. The lithium secondary battery as claimed in claim 13, wherein a weight of the acrylic monomer is greater than or equal to about 0.1 wt % and less than or equal to about 20 wt % of a weight of the electrolyte.

18. The lithium secondary battery as claimed in claim 13, wherein a weight ratio of the fluoroacrylic monomer and the acrylic monomer is in a range of about 3:7 to about 7:3.

19. The lithium secondary battery as claimed in claim 13, wherein one of:
an anode active material layer is free on the anode current collector before charging and discharging are performed, and
a ratio of an electrical capacity of the anode to an electrical capacity of the cathode is less than about 1 before charging and discharging are performed.

20. The lithium secondary battery as claimed in claim 13, further comprising a lithium metal layer disposed between the anode current collector and the electrolyte before charging is performed.
